(19) United States
(12) Patent Application Publication
(10) Pub. No.: US 2014/0096717 A1
(43) Pub. Date: Apr. 10, 2014

(54) PORTABLE WASTE DISPOSAL, STORAGE, AND TRANSPORT APPARATUS

(71) Applicant: Christie-Anne Springs, Calgary (CA)

(72) Inventor: Christie-Anne Springs, Calgary (CA)

(21) Appl. No.: 13/646,036

(22) Filed: Oct. 5, 2012

(51) Int. Cl. A01K 29/00

(52) U.S. Cl. 119/161

(57) ABSTRACT

An apparatus includes a container that includes a first cavity configured to provide a first opening on a first end of the container and a second cavity configured to provide a second opening on a second end of the container. The apparatus includes a first collar connected to the first end of the container and a first lid connected to the first collar. The first lid is configured to close to provide an airtight seal to the first cavity. The apparatus includes a second collar connected to the second end of the container and a second lid connected to the second collar. The second lid includes a pull-through port. The second lid is configured to close and provide access to the second cavity.

### BACKGROUND OF THE INVENTION

The number of pet owning households in the U.S. is at an all-time high. Approximately 72.9 million U.S. households own at least one pet. Because of the increase in the number of pet owners in urban areas, many states, cities, and municipalities have issued laws and ordinances that prohibit pet defecation on any public or private place used by the public unless the pet owner immediately collects and disposes the waste. Many states, cities, and municipalities have also issued leash laws and ordinances that prohibit the pet owner from permitting the pet to roam unattended. Failure to comply with these laws and ordinances can result in the issuance of a fine to the pet owner. As a consequence, urban pet owners typically walk their leashed pet on public streets, sidewalks, and in parks. When the pet defecates, the pet owner is required to immediately collect the waste, while maintaining control of the leashed pet.

### BRIEF SUMMARY OF THE INVENTION

According to one aspect of one or more embodiments of the present invention, an apparatus includes a container. The container includes a first cavity configured to provide a first opening on a first end of the container and a second cavity configured to provide a second opening on a second end of the container. The apparatus includes a first collar connected to the first end of the container and a first lid connected to the first collar. The first lid is configured to close to provide an airtight seal to the first cavity of the container. The apparatus includes a second collar connected to the second end of the container and a second lid connected to the second collar of the container. The second lid includes a pull-through port. The second lid is configured to close and provide access to the second cavity.

Other aspects of the present invention will be apparent from the following description and claims.

### BRIEF DESCRIPTION OF THE DRAWINGS

FIG. 1 shows an exploded view of a portable waste disposal, storage, and transport apparatus in accordance with one or more embodiments of the present invention.

FIG. 2 shows a partially exploded view of a portable waste disposal, storage, and transport apparatus in accordance with one or more embodiments of the present invention.

FIG. 3 shows a first end perspective of a portable waste disposal, storage, and transport apparatus in accordance with one or more embodiments of the present invention.

FIG. 4 shows a top side perspective of a portable waste disposal, storage, and transport apparatus in accordance with one or more embodiments of the present invention.

FIG. 5 shows a cross-section perspective of a portable waste disposal, storage, and transport apparatus in accordance with one or more embodiments of the present invention.

FIG. 6 shows a side perspective of a portable waste disposal, storage, and transport apparatus in accordance with one or more embodiments of the present invention.

### DETAILED DESCRIPTION OF THE INVENTION

One or more embodiments of the present invention will now be described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention.

A pet owner may wish to walk one or more pets in a public place. When the pet or pets defecate, the pet owner is required to collect and dispose of the waste in an appropriate waste bin. For safety reasons, the pet owner is required to maintain control of the pet or pets on a leash. As a consequence, the pet owner has only one free hand and the collection and disposal of pet waste is made difficult. Typically, it requires both hands to obtain a waste bag, collect the pet waste, secure the waste bag, and dispose the collected pet waste, if a suitable waste bin is available. In many instances, the pet owner must drop the leash or otherwise leave the pet or pets unattended to do so. This creates a safety issue for the pet, the pet owner, other animals, and the public.

If the pet owner wishes to take the pet on an extended walk, or multiple walks, or if the pet owner wishes to take a number of pets on a walk, the volume of collected pet waste may be substantial. In some instances, an appropriate waste bin to dispose of the pet waste is not readily available to the pet owner. As a consequence, the pet owner must carry the collected pet waste with them for the duration of the walk. As the number and volume of pet waste collections increases, it becomes difficult to carry the collected pet waste while maintaining control of the pet or pets.

If the owner wishes to take the pet or pets on a trip, an appropriate waste bin to dispose of the collected pet waste may not be readily available to the pet owner for an extended period of time. As a consequence, the pet owner may have to travel with the collected pet waste in close quarter to the pet owner. In addition to the burdensome volume of collected pet waste, the waste bags typically used to collect and store the pet waste are not airtight and there is an offensive odor to the collected pet waste. If an appropriate waste bin is not readily available, the pet owner must carry and/or travel with the collected pet waste and the offensive odor may prevent the pet owner from visiting people or places or engaging in activities he or she otherwise would. Because the waste bags are pliable, there is a risk that the waste bags may tear or otherwise open and expose the pet waste.

Accordingly, one or more embodiments of the present invention include a portable waste disposal, storage, and transport apparatus that is capable of securely disposing, storing, and transporting pet waste free from the associated offensive odors and configured for single hand operation.

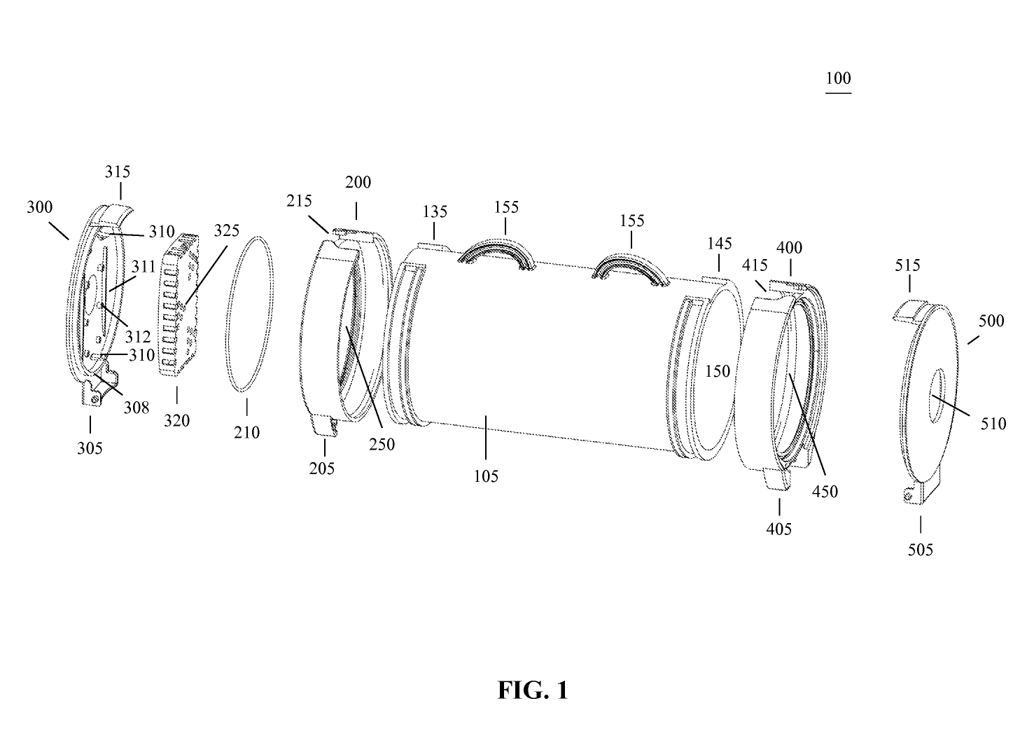

FIG. 1 shows an exploded view of a portable waste disposal, storage, and transport apparatus 100 in accordance with one or more embodiments of the present invention. In one or more embodiments of the present invention, apparatus 100 includes a container 105 that is cylindrical in shape. In one or more embodiments of the present invention, container 105 may be a rectangular box, triangular box, hexagonal box, or any other suitable shape. In one or more embodiments of the present invention, container 105 includes a transverse partition (not shown), a first cavity (not shown) disposed on a first side of the transverse partition configured to provide a first opening (not shown) on a first end 135 of container 105, and a second cavity (not shown) disposed on a second side of the transverse partition configured to provide a second opening 150 on a second end 145 of container 105. In one or more embodiments of the present invention, one or more strap loops 155 may be disposed on an exterior top side of container 105. In one or more embodiments of the present invention, a single strap loop, two strap loops, or a handle may be used. In one or more embodiments of the present invention, container 105 is a single rigid piece formed by a plastic injection molding process. In one or more embodiments of the present invention, container 105 is formed from plastic, wood, metal or various combinations of plastic, wood, or metal.

A first collar 200 is connected to the first end 135 of container 105. In one or more embodiments of the present invention, the first collar 200 is a single rigid piece formed by a plastic injection molding process and is hot-attached, or shrink-fit, to container 105 shortly after formation of the first collar 200 by the injection molding process. The hot-attach, or shrink-fit, process forms an airtight seal between the first collar 200 and container 105. In one or more embodiments of the present invention, the first collar 200 may be connected to container 105 by a threadable-connection that forms an airtight seal between the first collar 200 and container 105. One of ordinary skill in the art will recognize that other methods of connecting the first collar 200 and container 105 are within the scope of one or more embodiments of the claimed invention. In one or more embodiments of the present invention, the first collar 200 and container 105 are a single unibody piece. The first collar 200 provides a first collar opening 250 that is smaller in diameter than the first opening of container 105. The first collar 200 may include one or more feet (not shown) disposed on a basal side of the first collar 200. In one or more embodiments of the present invention, a first hinge catch 205 of the first collar 200 is shaped to act as one or more feet. The first collar 200 includes a first lid latch catch 215. A gasket 210 is disposed within a groove of the first collar 200. In one or more embodiments of the present invention, gasket 210 may be formed of rubber, silicone, or a plastic polymer/co-polymer.

A first lid 300 is connected to the first collar 200 by a first hinge 305. The first hinge 305 of the first lid 300 is mated to engage a first hinge catch 205 of the first collar 200. The first hinge 305 includes protrusions that serve as pivot pins when mated with the first hinge catch 205. In one or more embodiments of the present invention, the first hinge 305 and the first hinge catch 205 form a pivot hinge. One of ordinary skill in the art will recognize that other configurations and types of hinge and hinge catches are within the scope of one or more embodiments of the present invention. In one or more embodiments of the present invention, the first lid 300 is a single rigid piece formed by a plastic injection molding process.

The first lid 300 includes a first lid latch 315 configured to mate with a first lid latch catch 215 of the first collar 200. The first lid latch 315 includes a wedge-shaped protrusion that serves as a latch when mated with the first lid latch catch 215. One of ordinary skill in the art will recognize that first lid latch 315 and first lid latch catch 215 may be of varied geometry. In one or more embodiments of the present invention, the first lid latch 315 and the first lid latch catch 215 form a catch-latch. One of ordinary skill in the art will recognize that other latching mechanisms, including other push-to-open latches, button latches, or magnetic latches, or lift-to-open latches, button latches, or magnetic latches could be used in accordance with one or more embodiments of the present invention. With a single hand, the pet owner may depress the first lid latch 315 to clear the first lid latch 315 from the first lid latch catch 215, thereby allowing the first lid 300 to be opened. The first lid 300 is configured to open to provide access to the first cavity (not shown) of the container 105. With a single hand, the pet owner may close the first lid 300 and the first lid latch 315 will catch the first lid latch catch 215. The first lid 300 is configured to close to provide an airtight seal to the first cavity 115 of container 105. When the first lid 300 is in a closed position, a first lid lip 308 depresses gasket 210, disposed within a groove of first collar 200, to form a seal between the first lid 300 and the first collar 200. When the first lid 300 is closed, an airtight seal to the first cavity 115 of container 105 is formed.

In one or more embodiments of the present invention, a deodorizing compartment 320 is connected to the first lid 300. The deodorizing compartment 320 is held in place by clips 310 and secured by rattle-rails 311. While the clips 310 hold the deodorizing compartment 320 in place, the rattle-rails 311 prevent the deodorizing compartment 320 from rattling when the apparatus 100 is in motion. In one or more embodiments of the present invention, the deodorizing compartment 320 is connected to container 105. The deodorizing compartment 320 includes a plurality of holes 325 and may be raised off of the first lid 300 by standoffs 312 that allow for airflow through the deodorizing compartment 320. The deodorizing compartment 320 fits within the diameter of the first lid lip 308 such that the deodorizing compartment 320 is disposed within the airtight seal formed by the first lid 300 and the first collar 200 when the first lid 300 is closed. The deodorizing compartment 320 is configured to hold a deodorizing agent (not shown), a perfume agent (not shown), or both. In one or more embodiments of the present invention, the deodorizing agent is a carbon air filter. One of ordinary skill in the art will recognize that other deodorizing and perfume agents could be used in accordance with one or more embodiments of the present invention. The deodorizing compartment 320 may be removed to replace the deodorizing agent or perfume agent stored therein.

A second collar 400 is connected to the second end 145 of container 105. In one or more embodiments of the present invention, the second collar 400 is a single rigid piece formed by a plastic injection molding process and is hot-attached, or shrink-fit, to container 105 shortly after formation of the second collar 400 by the injection molding process. The hot-attach, or shrink-fit, process forms an airtight seal between the second collar 400 and container 105. In one or more embodiments of the present invention, the second collar 400 may be connected to container 105 by a threadable-connection that forms an airtight seal between the second collar 400 and container 105. One of ordinary skill in the art will recognize that other methods of connecting the second collar 400 and container 105 are within the scope of one or more embodiments of the claimed invention. In one or more embodiments of the present invention, the second collar 400 and container 105 are a single unibody piece. The second collar 400 provides a second collar opening 450 that is smaller in diameter than the second opening 150 of container 105. The second collar 400 may include one or more feet (not shown) disposed on a basal side of the second collar 400. In one or more embodiments of the present invention, a second hinge mating piece 405 of the second collar 400 is shaped to act as one or more feet. The second collar 400 includes a second lid latch catch 415.

A second lid 500 is connected to the second collar 400 by a second hinge 505. The second hinge 505 of the second lid 500 is mated to a second hinge catch 405 of the second collar 400. The second hinge 505 includes protrusions that serve as pivot pins when mated with the second hinge catch 405. In one or more embodiments of the present invention, the second hinge 505 and the second hinge catch 405 form a pivot hinge. One of ordinary skill in the art will recognize that other configurations and types of hinge and hinge catches are within the scope of one or more embodiments of the present invention. In one or more embodiments of the present invention, the second lid 500 is a single rigid piece formed by a plastic injection molding process.

The second lid 500 includes a second lid latch 515 configured to mate with a second lid latch catch 415 of the second collar 400. The second lid latch 515 includes a wedge-shaped protrusion that serves as a latch when mated with the second lid latch catch 415. In one or more embodiments of the present invention, the second lid latch 515 and the second lid latch catch 415 form a catch-latch. One of ordinary skill in the art will recognize that other latching mechanisms, including other push-to-open latches, button latches, or magnetic latches, or lift-to-open latches, button latches, or magnetic latches could be used in accordance with one or more embodiments of the present invention. With a single hand, the pet owner may depress the second lid latch 515 to clear the second lid latch 515 from the second lid latch catch 415, thereby allowing the second lid 500 to be opened. The second lid 500 is configured to open to provide access to the second cavity (not shown) of container 105. With a single hand, the pet owner may close the second lid 500 and the second lid latch 515 will snap into place with the second lid latch catch 415. The second lid 500 is configured to close and provide pull-through access to the second cavity. In one or more embodiments of the present invention, the second lid 500 includes a pull-through port 510. In one or more embodiments of the present invention, pull-through port 510 may be used to dispense, for example, plastic waste bags. A roll of plastic waste bags may include a plurality of plastic waste bags connected by perforated edges configured for individual dispensing.

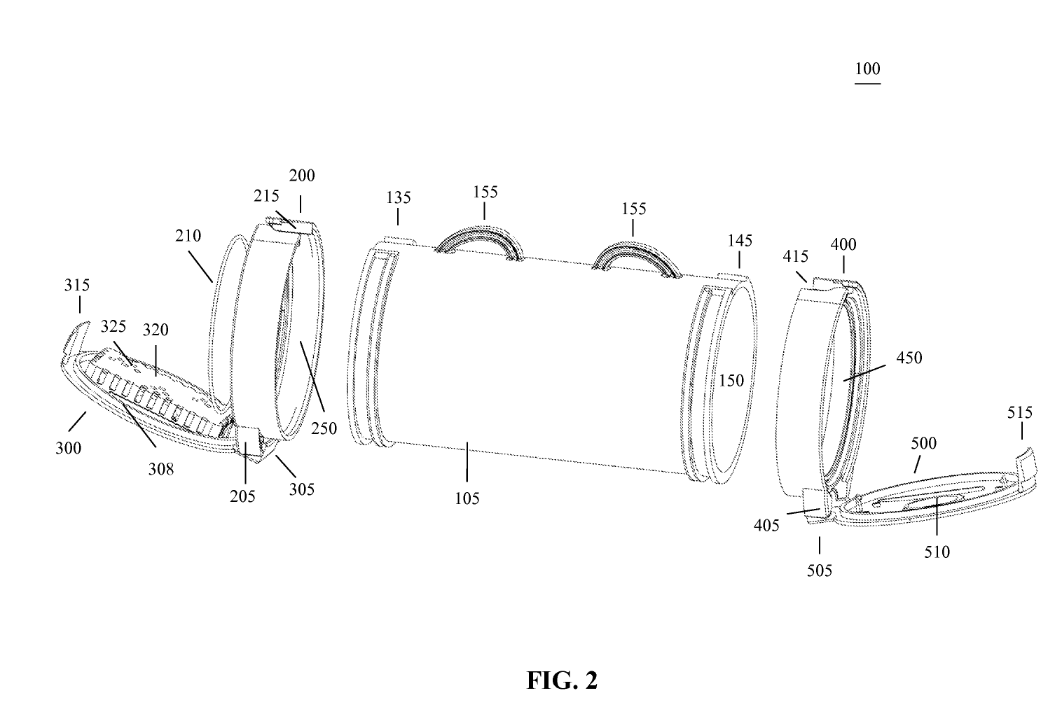

FIG. 2 shows a partially exploded view of a portable waste disposal, storage, and transport apparatus 100 in accordance with one or more embodiments of the present invention. The first hinge 305 of the first lid 300 is shown connected to the first hinge catch 205 of the first collar 200. The first hinge 305 and the first hinge catch 205 form a pivot hinge allowing the first lid 300 to open and close. When open, the pet owner has access to the first cavity 115 (not shown) of container 105. When closed, a first lid lip 308 depresses gasket 210, disposed within a groove of first collar 200, to form a seal between the first lid 300 and the first collar 200, thereby forming an airtight seal to the first cavity 115 of container 105. Similarly, the second hinge 505 of the second lid 500 is shown connected to the second hinge catch 405 of the second collar 400. The second hinge 505 and the second hinge catch 405 form a pivot hinge allowing the second lid 500 to open and close. When open, the pet owner has access to the second cavity (not shown) of container 105. When closed, the second cavity is accessible via pull-through port 510.

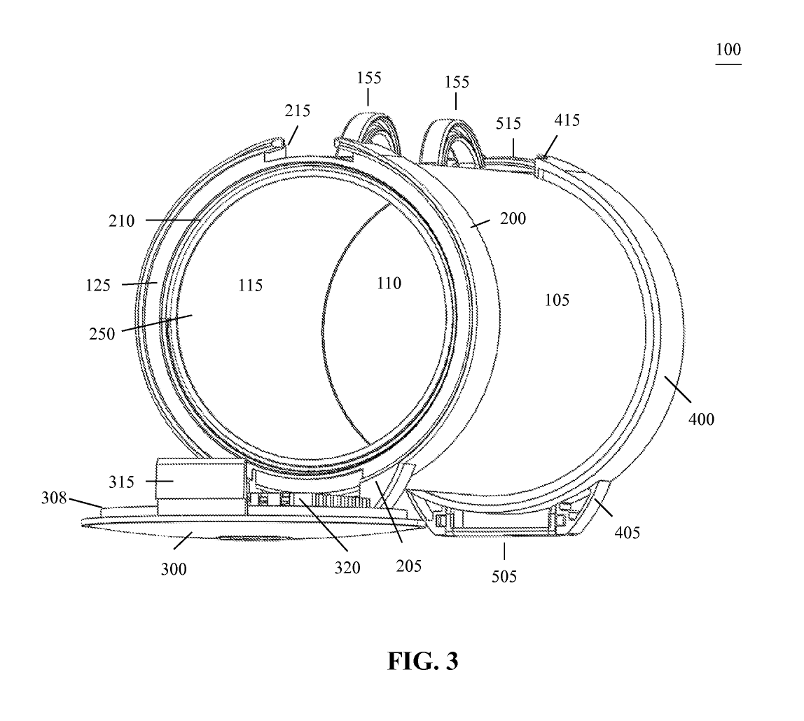

FIG. 3 shows a first end perspective of a portable waste disposal, storage, and transport apparatus 100 in accordance with one or more embodiments of the present invention. As noted above, when the first lid 300 is in the closed position, the first lid latch 315 mates with the first lid latch catch 215 holding the first lid 300 securely in place. When the first lid latch 315 is depressed, the first lid latch 315 clears the first lid latch catch 215 and the first lid 300 is free to open, exposing the first cavity 115. In one or more embodiments of the present invention, the first lid 300 is configured to open 90 degrees with respect to a closed position of the first lid 300 to prevent previously deposited waste collections to fall out of the first cavity 115 of container 105. The second lid (not shown) functions in a substantially similar manner. One of ordinary skill in the art will recognize that other opening angles are within the scope of one or more embodiments of the present invention. In addition, the second hinge 505 is shown mated with the second hinge catch 405.

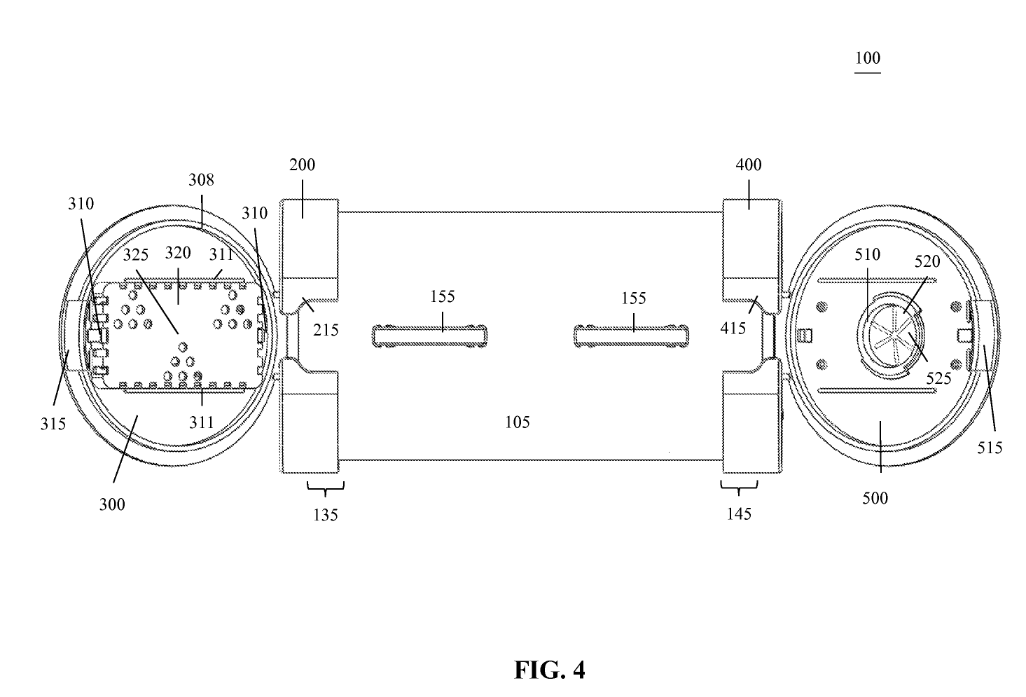

FIG. 4 shows a top side perspective of a portable waste disposal, storage, and transport apparatus 100 in accordance with one or more embodiments of the present invention. The first lid 300 is shown partially open. Deodorizing compartment 320 is shown attached to the first lid 300 by clips 310 and secured in place by rattle-rails 311. Deodorizing compartment 320 fits within the diameter of the first lid lip 308 such that the deodorizing compartment 320 is disposed within the airtight seal of the first cavity (not shown) formed by the first lid 300 and the first collar 200 when the first lid 300 is closed. The second lid 500 is shown partially open. In one or more embodiments of the present invention, pull-through port 510 may provide pull-through access to the second cavity (not shown) suitable for dispensing plastic waste bags. In one or more embodiments of the present invention, a pull-through dispenser 520 may be connected to pull-through port 510 of the second lid 500. In one or more embodiments of the present invention, the pull-through dispenser 520 may be configured to screw into pull-through port 510. In one or more embodiments of the present invention, the pull-through dispenser 520 may be configured to snap-in to pull-through port 510. In one or more embodiments of the present invention, the pull-through dispenser 520 may include one or more semi-rigid plastic teeth 525 suitable for dispensing plastic waste bags. In one or more embodiments of the present invention, a roll of perforated plastic waste bags may be disposed within the second cavity and made accessible to the pet owner when the second lid 500 is in the closed position via pull-through dispenser 520.

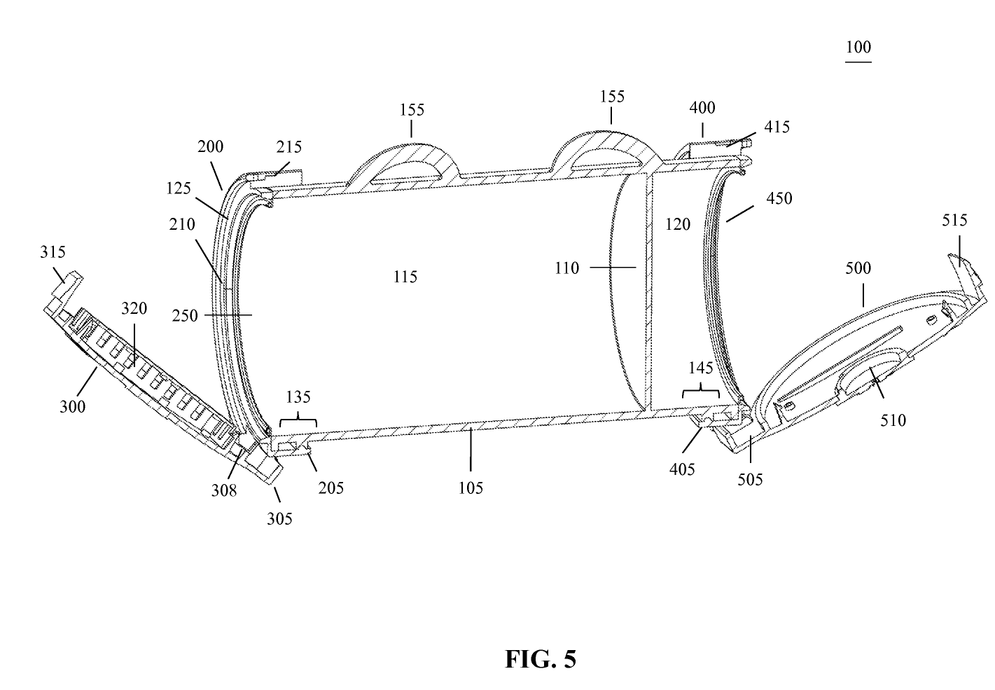

FIG. 5 shows a cross-section perspective of a portable waste disposal, storage, and transport apparatus 100 in accordance with one or more embodiments of the present invention. Container 105 includes a transverse partition 110, a first cavity 115 disposed on a first side of the transverse partition 110 configured to provide a first opening 125 on a first end 135 of the container, and a second cavity 120 disposed on a second side of the transverse partition 110 configured to provide a second opening (not shown) on a second end 145 of container 105. In one or more embodiments of the present invention, the first cavity 115 is larger than the second cavity 120. In one or more embodiments of the present invention, the first cavity 115 serves as an airtight waste storage compartment. In one or more embodiments of the present invention, the second cavity 120 holds a roll of plastic waste bags individually dispensed through the access port 510.

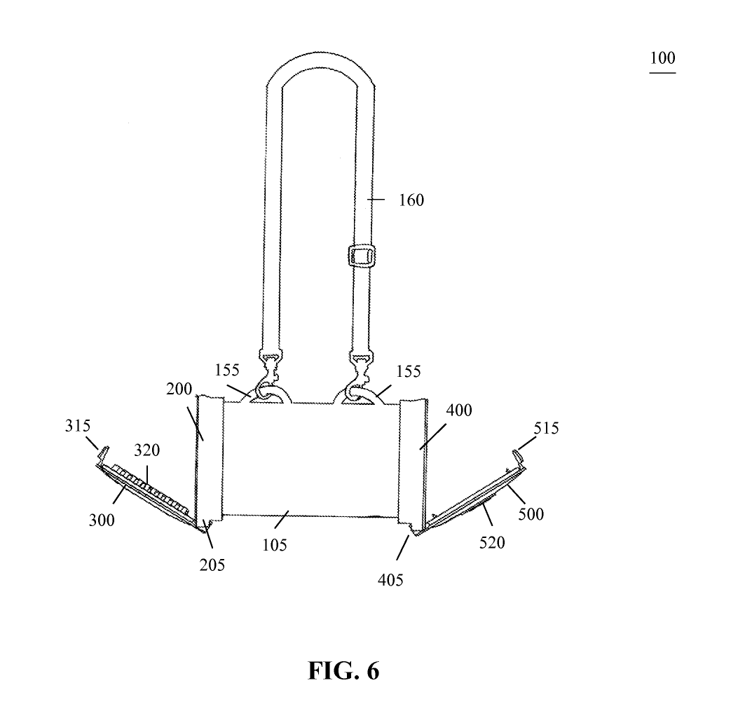

FIG. 6 shows a side perspective of a portable waste disposal, storage, and transport apparatus 100 in accordance with one or more embodiments of the present invention. In one or more embodiments of the present invention, a shoulder strap 160 is connected to strap loops 155. For purposes of illustration only, the pet owner may hold the leashed pet with a first hand and carry apparatus 100 on their opposing shoulder using shoulder strap 160. During a walk, when the pet defecates, the pet owner may use the hand not holding the leash to open the first lid 300 and expose the first cavity 115, or waste storage compartment, of container 105. The pet owner may then use the free hand to dispense a plastic bag from the pull-through dispenser 520 of the second lid 500. Using the same free hand, the pet owner may collect the pet waste into the plastic waste bag, dispose the collected waste into the waste storage compartment, and close the first lid 300. The pet owner is then free to continue their walk, storing and transporting the collected waste until such time an appropriate waste bin can be found. Because the first cavity 115 is airtight, the pet owner can do so free from offensive odors.

Advantages of one or more embodiments of the present invention may include one or more of the following:

In one or more embodiments of the present invention, a portable waste disposal, storage, and transport apparatus provides for single hand operation of the apparatus. A pet owner may use a first hand to hold the pet's leash. The pet owner may place a shoulder strap of the apparatus over the opposing shoulder. When the pet defecates, the pet owner may use a second hand to dispense a plastic waste bag from the apparatus, collect the pet waste in the plastic waste bag, open the lid, dispose the collected pet waste in the waste storage compartment, and close the lid to store and/or transport the collected pet waste. In this way the pet owner may continue their activities with minimal interruption while maintaining control of the pet.

In one or more embodiments of the present invention, a portable waste disposal, storage, and transport apparatus provides for the disposal, storage, and transport of a plurality of pet waste collections, thereby allowing the pet owner the freedom to take their pet on an extended walk, a plurality of walks, or a trip, or take a plurality of pets on a walk before having to seek out an appropriate waste bin to discard the collected pet waste.

In one or more embodiments of the present invention, a portable waste disposal, storage, and transport apparatus provides for the disposal, storage, and transport of pet waste free from offensive odors. The waste storage compartment is airtight and a deodorizing compartment may include a deodorizing agent that can be easily replaced.

In one or more embodiments of the present invention, a portable waste disposal, storage, and transport apparatus provides for the disposal, storage, and transport of pet waste free from offensive odors that attract the attention of unfriendly wildlife.

In one or more embodiments of the present invention, a portable waste disposal, storage, and transport apparatus may be rigid, thereby preventing the contents of the waste storage compartment from being compressed and inadvertently opened when other items are placed on or near the apparatus.

In one or more embodiments of the present invention, a portable waste disposal, storage, and transport apparatus is easily identifiable as such, thereby preventing the apparatus from being mistakenly identified as a purse, hand bag, lunch bag, or other piece of luggage and the accompanying embarrassment.

In one or more embodiments of the present invention, a portable waste disposal, storage, and transport apparatus may include a lid that does not open more than 90 degrees. This prevents prior deposits of collected waste from falling out of the apparatus when making subsequent deposits.

In one or more embodiments of the present invention, a portable waste disposal, storage, and transport apparatus may include a lid latch that is open through the lid collar so that it may be easily opened even if the pet owner is wearing gloves or mittens and prevents the breaking of female pet owner's nails when opening and closing the lid.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

What is claimed is:

1. An apparatus comprising:
a container comprising:
a first cavity configured to provide a first opening on a first end of the container, and
a second cavity configured to provide a second opening on a second end of the container;
a first collar connected to the first end of the container;
a first lid connected to the first collar, wherein the first lid is configured to close to provide an airtight seal to the first cavity of the container;
a second collar connected to the second end of the container; and
a second lid connected to the second collar, the second lid comprising a pull-through port, wherein the second lid is configured to close and provide access to the second cavity.

2. The apparatus of claim 1, wherein the container further comprises:
one or more strap loops disposed on an exterior of the container.

3. The apparatus of claim 2, wherein the apparatus further comprises:
a shoulder strap connected to the one or more strap loops.

4. The apparatus of claim 1, wherein the first collar comprises:
a gasket disposed within a groove of the first collar.

5. The apparatus of claim 1, wherein the first collar comprises:
one or more feet disposed on a basal side of the first collar.

6. The apparatus of claim 1, wherein the second collar comprises:
one or more feet disposed on a basal side of the second collar.

7. The apparatus of claim 1,
wherein the first lid comprises a deodorizing compartment disposed on a first side of the first lid facing the first cavity of the container.

8. The apparatus of claim 1,
wherein the container comprises a deodorizing compartment disposed within the first cavity of the container.

9. The apparatus of claim 1,
wherein the first lid comprises a latch configured to open and close the first lid with respect to the first collar, and
wherein the second lid comprises a latch configured to open and close the second lid with respect to the second collar.

10. The apparatus of claim 1,
wherein the first lid latch is configured to open and close with a single hand.

11. The apparatus of claim 1,
wherein the first lid is configured to open 90 degrees with respect to a closed position of the first lid.

12. The apparatus of claim 1,
wherein the second lid latch is configured to open and close with a single hand.

13. The apparatus of claim 1,
wherein the second lid is configured to open 90 degrees with respect to a closed position of the second lid.

14. The apparatus of claim 1,
wherein a diameter of the first collar is smaller than a diameter of the first opening on the first end of the container, and
wherein a diameter of the second collar is smaller than a diameter of the second opening on the second end of the container.

15. The apparatus of claim 1,
wherein the first cavity is larger in volume than the second cavity.

16. The apparatus of claim 1,
wherein the container is cylindrical.

17. The apparatus of claim 1,
wherein the container is rigid.

18. The apparatus of claim 1,
wherein the first collar is injection molded and hot attached to the first end of the container.

19. The apparatus of claim 1,
wherein the first collar is connected to the container by a threadable connection.

20. The apparatus of claim 1,
wherein the first collar, second collar, and container are a single unibody piece.
